(19) United States
(12) Patent Application Publication
(10) Pub. No.: US 2025/0226924 A1
(43) Pub. Date: Jul. 10, 2025

(54) COLLISION HANDLING IN AND HARQ-ACK CODEBOOK GENERATION FOR SIDELINK CARRIER AGGREGATION

(71) Applicant: Intel Corporation, Santa Clara, CA (US)

(72) Inventors: Gang Xiong, Beaverton, OR (US); Salvatore Talarico, Los Gatos, CA (US); Kilian Peter Anton Roth, München (DE)

(21) Appl. No.: 18/852,636

(22) PCT Filed: Jul. 3, 2023
(86) PCT No.: PCT/US2023/026852

§ 371 Date: Sep. 30, 2024

Related U.S. Application Data
(60) Provisional application No. 63/393,726, filed on Jul. 29, 2022.
(60) Provisional application No. 63/397,269, filed on Aug. 11, 2022.

(51) Int. Cl. H04L 1/1812; H04W 72/1273; H04W 72/40; H04W 72/566; H04W 92/18

(52) U.S. Cl. CPC H04L 1/1812; H04W 72/1273; H04W 72/40; H04W 72/566; H04W 92/18

(57) ABSTRACT

An apparatus and system of supporting sidelink carrier aggregation are described. Mechanisms for Type 1 and Type 2 sidelink hybrid automatic repeat request-acknowledgement (HARQ-ACK) codebook generation for carrier aggregation are described. A sidelink carrier index is included in downlink control information (DCI) format 3 0 received by a user equipment. The sidelink carrier index indicates the sidelink carrier used for resource allocation of a physical sidelink shared channel (PSSCH) and physical sidelink control channel (PSCCH). The HARQ-ACK for a sidelink serving cell is generated and the sidelink HARQ-ACK information bits are concatenated in accordance with ascending order of sidelink serving cell index. Collision handling and prioritization among sidelink transmissions and reception, as well as uplink transmissions during sidelink carrier aggregation are described.

### PRIORITY CLAIM

This application claims the benefit of priority to U.S. Provisional Patent Application Ser. No. 63/393,726, filed Jul. 29, 2022, and U.S. Provisional Patent Application Ser. No. 63/397,269, filed Aug. 11, 2022, each of which is incorporated herein by reference in its entirety.

### TECHNICAL FIELD

Embodiments pertain to communications in 3GPP networks. In particular, some embodiments relate to sidelink communications in next generation networks.

### BACKGROUND

The use and complexity of wireless systems has increased due to both an increase in the types of electronic devices using network resources as well as the amount of data and bandwidth being used by various applications, such as video streaming, operating on the electronic devices. As expected, a number of issues abound with the advent of any new technology, including complexities related to the use of sidelink communications.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates a sidelink Hybrid Automatic Repeat Request acknowledgement (HARQ-ACK) report in accordance with some embodiments.

FIG. 4 illustrates type 1 sidelink HARQ-ACK codebook generation in accordance with some embodiments.

FIG. 5 illustrates type 1 sidelink HARQ-ACK codebook on a physical uplink control channel (PUCCH) in accordance with some embodiments.

FIG. 6 illustrates prioritization of a PUCCH with sidelink HARQ-ACK feedback and physical sidelink feedback channel (PSFCH) transmission in accordance with some embodiments.

FIG. 7 illustrates prioritization between physical sidelink shared channel (PSSCH)/physical sidelink control channel (PSCCH) transmission and PSFCH reception in accordance with some embodiments.

FIG. 8 illustrates prioritization between PSSCH/PSCCH transmission and PSFCH reception in accordance with some embodiments.

FIG. 9 illustrates prioritization between uplink (UL) transmission and sidelink (SL) transmissions in more than one sidelink carrier in accordance with some embodiments.

FIG. 10 illustrates prioritization between UL transmission and SL transmissions in more than one sidelink carrier in accordance with some embodiments.

FIG. 11 illustrates prioritization between UL transmission, SL transmission, and SL reception in accordance with some embodiments.

FIG. 12 illustrates another prioritization between UL transmission, SL transmission, and SL reception in accordance with some embodiments.

FIG. 13 illustrates a process of providing sidelink HARQ-ACK information in accordance with some embodiments.

FIG. 14 illustrates a process of prioritization of transmissions or reception including sidelink transmissions or receptions in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

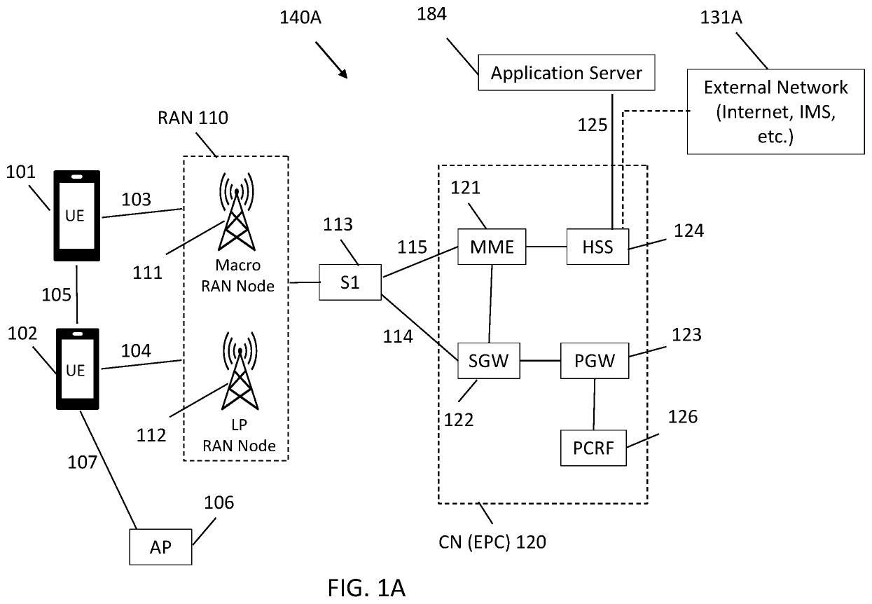

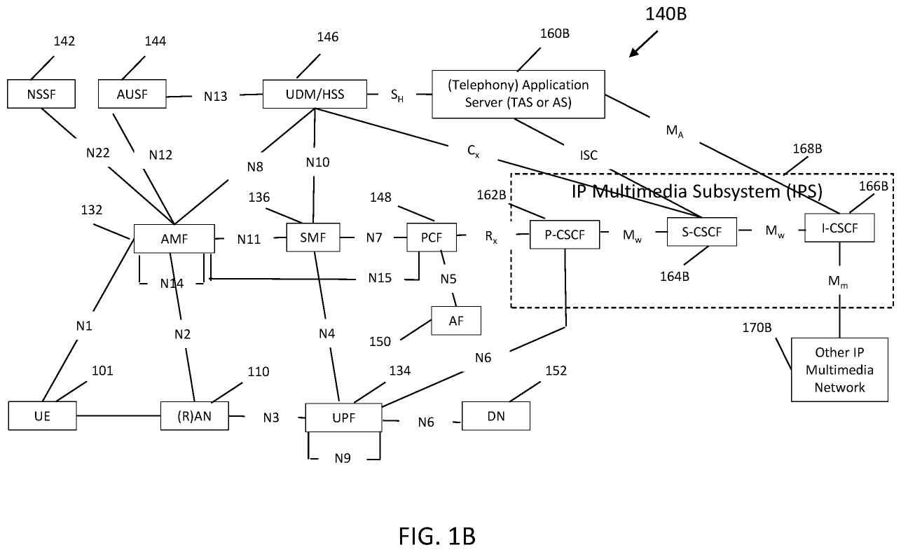

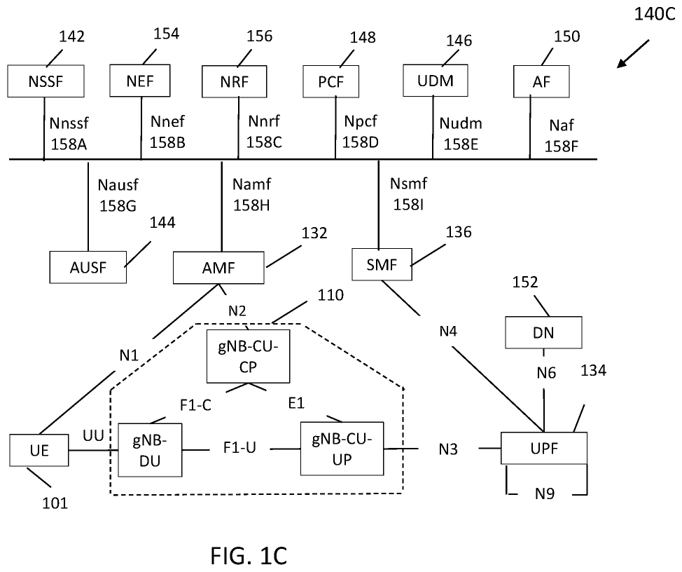

FIG. 1A illustrates an architecture of a network in accordance with some aspects. The network 140A includes 3GPP LTE/4G and NG network functions that may be extended to 6G and later generation functions. Accordingly, although 5G is referred to herein, it is to be understood that this is to extend as able to 6G (and later) structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHZ, 3.6-3.8 GHz, and other frequencies and Spectrum Access System (SAS) in 3.55-3.7 GHZ and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The RAN 110 may contain one or more gNBs, one or more of which may be implemented by multiple units. Note that although gNBs may be referred to herein, the same aspects may apply to other generation NodeBs, such as 6^{th} generation NodeBs—and thus may be alternately referred to as next generation NodeB (xNB).

Each of the gNBs may implement protocol entities in the 3GPP protocol stack, in which the layers are considered to be ordered, from lowest to highest, in the order Physical (PHY), Medium Access Control (MAC), Radio Link Control (RLC), Packet Data Convergence Control (PDCP), and Radio Resource Control (RRC)/Service Data Adaptation Protocol (SDAP) (for the control plane/user plane). The protocol layers in each gNB may be distributed in different units—a Central Unit (CU), at least one Distributed Unit (DU), and a Remote Radio Head (RRH). The CU may provide functionalities such as the control the transfer of user data, and effect mobility control, radio access network sharing, positioning, and session management, except those functions allocated exclusively to the DU.

The higher protocol layers (PDCP and RRC for the control plane/PDCP and SDAP for the user plane) may be implemented in the CU, and the RLC and MAC layers may be implemented in the DU. The PHY layer may be split, with the higher PHY layer also implemented in the DU, while the lower PHY layer is implemented in the RRH. The CU, DU and RRH may be implemented by different manufacturers, but may nevertheless be connected by the appropriate interfaces therebetween. The CU may be connected with multiple DUs.

The interfaces within the gNB include the E1 and front-haul (F) F1 interface. The E1 interface may be between a CU control plane (gNB-CU-CP) and the CU user plane (gNB-CU-UP) and thus may support the exchange of signaling information between the control plane and the user plane through E1AP service. The E1 interface may separate Radio Network Layer and Transport Network Layer and enable exchange of UE associated information and non-UE associated information. The E1AP services may be non UE-associated services that are related to the entire E1 interface instance between the gNB-CU-CP and gNB-CU-UP using a non UE-associated signaling connection and UE-associated services that are related to a single UE and are associated with a UE-associated signaling connection that is maintained for the UE.

The F1 interface may be disposed between the CU and the DU. The CU may control the operation of the DU over the F1 interface. As the signaling in the gNB is split into control plane and user plane signaling, the F1 interface may be split into the F1-C interface for control plane signaling between the gNB-DU and the gNB-CU-CP, and the F1-U interface for user plane signaling between the gNB-DU and the gNB-CU-UP, which support control plane and user plane separation. The F1 interface may separate the Radio Network and Transport Network Layers and enable exchange of UE associated information and non-UE associated information. In addition, an F2 interface may be between the lower and upper parts of the NR PHY layer. The F2 interface may also be separated into F2-C and F2-U interfaces based on control plane and user plane functionalities.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission-reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a core network (CN) 120. The NG-RAN 110 can include a plurality of nodes, such as gNBs and NG-eNBs. The CN 120 (e.g., a 5G core network (5GC)) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a master node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other CN network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g. an IMS operated by a different network operator.

In some aspects, the UDM/HSS 146 may be coupled to an application server (AS) 160B, which can include a telephony application server (TAS) or another application server. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

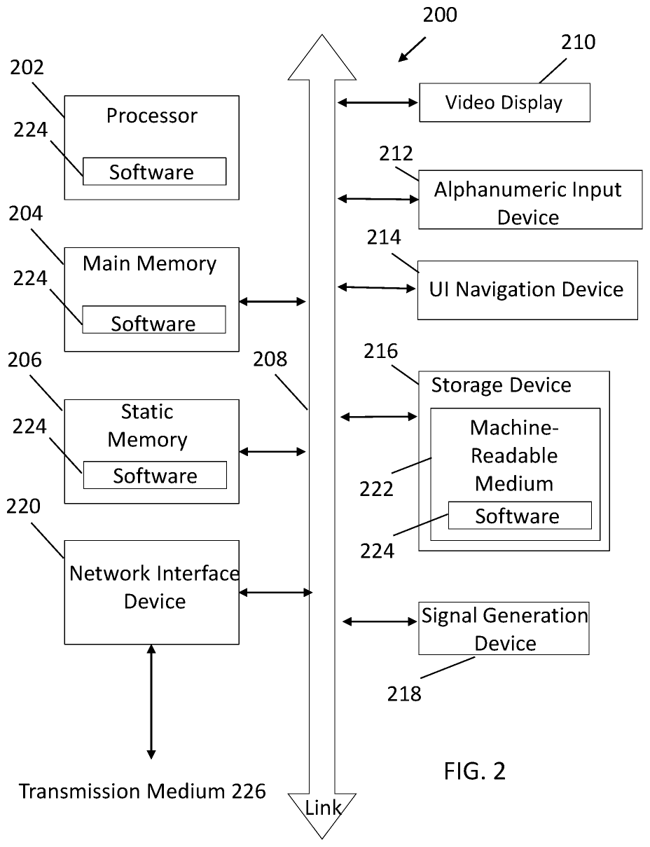

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5^{th} generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth (r), Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety re-lated applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHZ, 3.6-3.8 GHz and further frequencies and SAS=Spectrum Access System/CBRS=Citizen Broadband Radio System in 3.55-3.7 GHZ and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHZ, 1710-2025 MHz, 2110-2200 MHz, 2300-2400 MHZ, 2.4-2.4835 GHz (note: it is an ISM band with global availability and it is used by Wi-Fi technology family (11b/g/n/ax) and also by Bluetooth), 2500-2690 MHz, 698-790 MHZ, 610-790 MHz, 3400-3600 MHZ, 3400-3800 MHZ, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHZ, 3800-4200 MHZ, 3.5 GHz bands, 700 MHz bands, bands within the 24.25-86 GHz range, etc.), spectrum made available under FCC's “Spectrum Frontier” 5G initiative (including 27.5-28.35 GHZ, 29.1-29.25 GHZ, 31-31.3 GHZ, 37-38.6 GHZ, 38.6-40 GHz, 42-42.5 GHZ, 57-64 GHz, 71-76 GHZ, 81-86 GHz and 92-94 GHZ, etc), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHZ) and WiGig Band 4 (63.72-65.88 GHZ), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Aspects described herein can also implement a hierarchical application of the scheme is possible, e.g., by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc.

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

As above, mobile communication has evolved significantly from early voice systems to the modern highly sophisticated integrated communication platforms used in the current generation of the network. The next generation wireless communication system, 5G, or new radio (NR) is expected to provide access to information and sharing of data anywhere, anytime by an increasing number and type of users and applications. NR is to be a unified network/system whose target is to meet vastly different and sometime conflicting performance dimensions and services. Such diverse multi-dimensional requirements are driven by different services and applications.

Sidelink communication was introduced in Rel-16 of the 3GPP specification. One of the targets of sidelink communication is advanced vehicle-to-anything (V2X) applications. Power saving solutions introduced in Rel-17, including partial sensing and discontinuous reception (DRX) and inter-UE coordination, improve power consumption for battery limited terminals and reliability of sidelink transmissions.

Although NR sidelink was initially developed for V2X applications, there is growing interest in the industry to expand the applicability of NR sidelink to commercial use cases. In particular, an increase in the sidelink data rate is desirable for commercial sidelink applications. This increase may be achieved with the support of sidelink carrier aggregation.

In Rel-16, two modes of resource allocation were defined for sidelink communication that are applied in the V2X application: 1) mode 1, where the gNB allocates the resources for sidelink communications; and 2) mode 2, where the UE autonomously selects the resources for sidelink communication based on a sensing and resource selection procedure. For mode 1 resource allocation, a UE may transmit a sidelink HARQ-ACK report on the PUCCH and PUSC). Further, both a Type 1 and Type 2 sidelink HARQ-ACK codebook is supported in Rel-16.

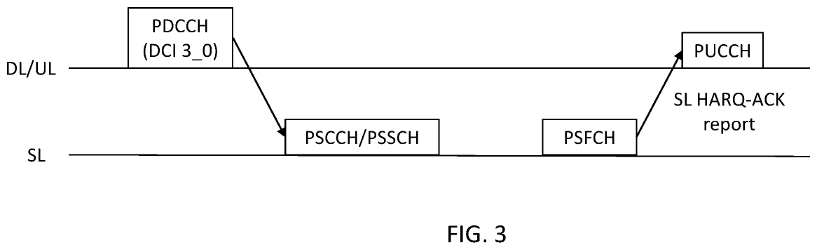

FIG. 3 illustrates a sidelink Hybrid Automatic Repeat Request acknowledgement (HARQ-ACK) report in accordance with some embodiments. In particular, FIG. 3 illustrates one example of a sidelink HARQ-ACK report on a PUCCH for mode 1 resource allocation. In FIG. 3, a Tx UE transmits a PSCCH and PSSCH in a resource allocated from the gNB via downlink control format (DCI) format 3_0 carried by a PDCCH. Further, a Rx UE sends the sidelink HARQ-ACK feedback in a PSFCH to the Tx UE. Subsequently, the Tx UE sends the sidelink HARQ-ACK report in a PUCCH resource indicated in the DCI format 3_0. Multiple sidelink HARQ-ACK information bits on the PUCCH may be aggregated using the Type 1 and Type 2 sidelink HARQ-ACK codebook.

In Rel-16 and Rel-17, only a single carrier is considered for sidelink communication. When sidelink carrier aggregation (CA) is supported, sets of design considerations may be taken for the sidelink HARQ-ACK codebook generation. Mechanisms for both Type 1 sidelink HARQ-ACK codebook generation for CA and Type 2 sidelink HARQ-ACK codebook generation for CA are described herein. Note that in the following embodiments, terminology “sidelink carrier” is interchangeable with “sidelink cell”, and “sidelink serving cell”.

In one embodiment, a sidelink carrier index may be included in the DCI format 3_0 to indicate the sidelink carrier used for resource allocation of the PSCCH and PSSCH. The size of the field related to the sidelink carrier index may be determined as ┌log₂(N_{cell}^{SL})┐, where N_{cell}^{SL} is the number of sidelink carriers configured by higher layers.

Embodiments related to Type 1 sidelink HARQ-ACK codebook generation for CA are provided as follows:

In one embodiment, for Type 1 sidelink HARQ-ACK codebook generation for CA, sidelink HARQ-ACK bits are generated per sidelink carrier and then concatenated in ascending (or descending) order of sidelink serving cell index.

The text in Clause 16.5.1 in TS38.213 for Type 1 HARQ-ACK codebook generation may be updated as follows:

A UE determines õ₀^{ACK}, õ₁^{ACK}, . . . , õ₀_{_{ACK}}₋₁^{ACK} HARQ-ACK information bits, for a total number of O_{ACK} HARQ-ACK information bits according to the following pseudo-code

```
The cardinality of the set M_{A,c} defines a total number M_{c} of occasions for candidate
PSSCH transmissions with corresponding PSFCH reception occasions for sidelink
serving cell c corresponding to the HARQ-ACK information bits,
Set c = 0 − sidelink serving cell index: lower indexes correspond to lower RRC
indexes of corresponding cell
Set j = 0 − HARQ-ACK information bit index
Set N_{cells}^{SL} to the number of sidelink serving cells configured by higher layers for
the UE
while c < N_{cells}^{SL}
  while j < M_{c}
    õⱼ^{ACK} = HARQ-ACK information bit of serving cell c;
    j = j + 1;
  end while
  c = c + 1;
end while
```

If O_{ACK}≤11, the UE determines a number of HARQ-ACK information bits N_{HARQ-ACK} for obtaining a transmission power for a PUCCH, as described in clause 7.2.1, as n_{HARQ-ACK}=Σ_{c=0}^{N}^{_{cells}}^{^{SL}}Σₘ₌₀^{M-1}N_{m,c}^{received} where N_{m,c}^{received} is a number of HARQ-ACK information bits determined for corresponding PSSCH transmissions with corresponding PSFCH reception occasions in PSFCH reception occasion m for sidelink serving cell c.

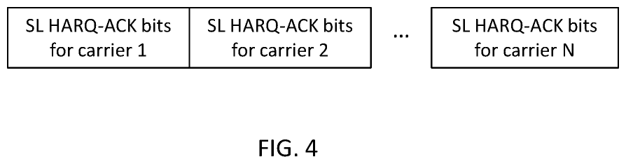

FIG. 4 illustrates type 1 sidelink HARQ-ACK codebook generation in accordance with some embodiments. In the example shown in FIG. 4, the SL HARQ-ACK for a sidelink serving cell is generated first in accordance with existing specification as defined in Clause 16.5.1 in TS38.213. Further, SL HARQ-ACK information bits are concatenated in accordance with ascending order of sidelink serving cell index.

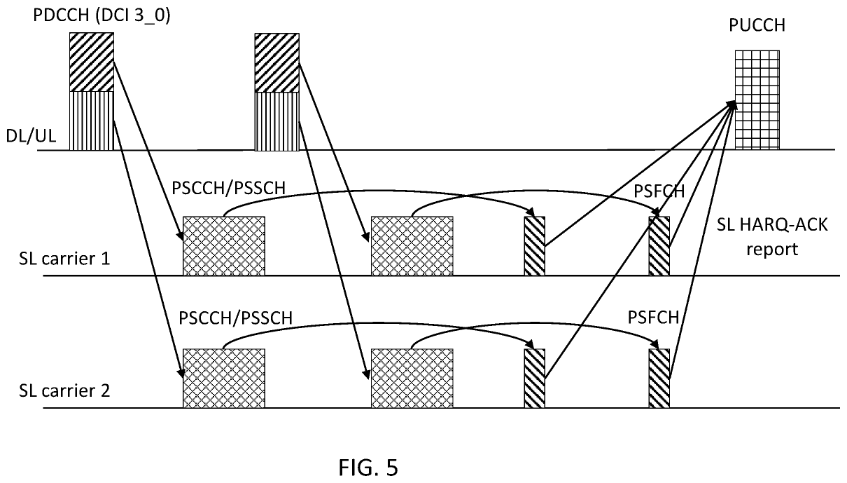

FIG. 5 illustrates type 1 sidelink HARQ-ACK codebook on a PUCCH in accordance with some embodiments. In the example shown in FIG. 5, four PSCCH/PSSCH transmissions are allocated by DCI format 3_0 carried by the PDCCH, respectively. Further, four sidelink HARQ-ACK information bits are generated and carried by the PUCCH, which is indicated by the corresponding field in the DCI format 3_0.

### Type 2 Sidelink HARQ-ACK Codebook Generation for CA

Embodiments related to Type 2 sidelink HARQ-ACK codebook generation for CA are provided as follows:

In one embodiment, one field of total sidelink assignment index (T-SAI) may be included in the DCI format 3_0 to indicate the total number of sidelink HARQ-ACK feedback information bits for CA. In particular, two bit fields as defined in Table 16.5.2.1-1 may be used for the T-SAI field as follows:

TABLE 16.5.2.1-1
Value of counter SAI and total SAI in DCI format 3_0

| | | Number of PDCCH monitoring occasions in |
|---|---|---|
| | | which DCI format 3_0 scheduling PSSCH |
| SAI | V_{C-SAI}^{SL} | transmissions with corresponding PSFCH |
| MSB, | or | reception occasions is present, denoted as Y |
| LSB | V_{T-SAI}^{SL} | and Y ≥ 1 |
| 0, 0 | 1 | (Y − 1)mod4 + 1 = 1 |
| 0, 1 | 2 | (Y − 1)mod4 + 1 = 2 |
| 1, 0 | 3 | (Y − 1)mod4 + 1 = 3 |
| 1, 1 | 4 | (Y − 1)mod4 + 1 = 4 |

Embodiments related to Type 2 sidelink HARQ-ACK codebook generation for CA are provided as follows:

In another embodiment, the set of PDCCH monitoring occasions for DCI format 3_0 for scheduling PSSCH transmissions with associated PSFCH reception occasions is defined as the union of PDCCH monitoring occasions in the active downlink (DL) bandwidth part (BWP) of the configured serving cells, in ascending order of start time of the associated search space sets. The cardinality of the set of PDCCH monitoring occasions defines a total number M of PDCCH monitoring occasions.

A value of a counter SAI field in DCI format 3_0, excluding DCI format 3_0 for the SL configured grant Type 2 activation, denotes an accumulative number of {sidelink carrier, PDCCH monitoring occasions}-pair(s) where PSSCH transmissions with associated PSFCH receptions are scheduled, up to a current PDCCH monitoring occasion, first in ascending order of sidelink carrier index and then in ascending order of PDCCH monitoring occasion index m, where 0≤m<M.

A value of the total SAI, when present, in DCI format 3_0, excluding DCI format 3_0 for the SL configured grant Type 2 activation, denotes the total number {sidelink carrier, PDCCH monitoring occasions}-pair(s) where PSSCH transmissions with associated PSFCH receptions are scheduled, up to a current PDCCH monitoring occasion, and is updated from PDCCH monitoring occasion to PDCCH monitoring occasion.

In another embodiment, for Type 2 HARQ-ACK codebook generation on PUCCH, the T-SAI and sidelink carrier index are included in the pseudo-code.

In particular, the text in Clause 16.5.2 in TS38.213 for Type 2 HARQ-ACK codebook generation may be updated as follows:

Denote by V_{C-SAI,m}^{SL} the value of the counter SAI in DCI format 3_0 in PDCCH monitoring occasion m according to Table 16.5.2.1-1.

Denote by V_{T-SAI,m}^{SL} the value of the total SAI in DCI format 3_0 in PDCCH monitoring occasion m according to Table 16.5.2.1-1.

If the UE transmits HARQ-ACK information in a PUCCH in slot n, the UE determines the õ₀^{ACK}, õ₁^{ACK}, . . . , õ₀_{_{ACK}}₋₁^{ACK}, for a total number of O_{ACK} HARQ-ACK information bits, according to the following pseudo-code:

```
Set m = 0 − PDCCH with DCI format 3_0 monitoring occasion index: lower
  index corresponds to earlier PDCCH with DCI format 3_0 monitoring
  occasion
Set j = 0
Set Vₜₑₘₚ = 0
Set V_{temp,2} = 0
Set Vₛ = Ø
Set N_{cells}^{SL} to the number of sidelink serving cells configured by higher layers
  for the UE
Set M to the number of PDCCH monitoring occasions
while m < M
    set c = 0 − sidelink serving cell index: lower indexes correspond to
    lower RRC indexes of corresponding cell
    while c < N_{cell}^{SL}
      if PDCCH monitoring occasion m is before an active UL BWP
      change on the serving cell of PUCCH transmission
        m = M;
      else
        if there is a PSFCH reception occasion associated with a PSSCH
        transmission scheduled by a DCI format in PDCCH monitoring
        occasion m
          if V_{C-SAI,m}^{SL} ≤ Vₜₑₘₚ
            j = j + 1;
          end if
          Vₜₑₘₚ = V_{C-SAI,m}^{SL}
          if V_{T-SA,m}^{SL} = Ø
            V_{temp,2} = V_{C-SAI,c,m}^{SL}
          else
            V_{temp,2} = V_{T-SAI,m}^{SL}
          end if
          õ_{4j+V}_{_{C-SAI,m}}₋₁_{^{SL}}^{ACK} = HARQ-ACK information bit
          V_{S} = V_{S} ∪ {4j + V_{C-SAI,m}^{SL} − 1}
        end if
      end if
      c = c + 1;
    end while
    m = m + 1;
  end while
  if Vₜₑₘₚ₂ < Vₜₑₘₚ
    j = j + 1
end if
  O_{ACK} = 4 · j + Vₜₑₘₚ
  Õᵢ^{ACK} = NACK for any i ∈ {0,1, ... , O_{ACK} − 1}\V_{S}
Set c = 0
while c < N_{cells}^{SL}
  if a SL configured grant Type 1 is configured for a UE, or a SL configured
  grant Type 2 is configured and activated for a UE, and the SL configured
  grant provides a grant for PSSCH transmissions, including the PSSCH
  transmission(s) associated with the corresponding activation DCI format
  3_0, with PSFCH reception occasions in a slot n − K₁, where K₁ is the k
  value for the SL configured grant as described in clause 16.5
    O_{ACK} = O_{ACK} + 1;
    o_{O}_{^{ACK−1}}^{ACK}= HARQ-ACK information bit associated with the PSFCH
    reception occasions associated with the PSSCH transmissions
    scheduled by the SL configured grant
  end if
  c = c + 1;
end while
```

In another embodiment, for power control of a PUCCH carrying sidelink HARQ-ACK information bits, the number of sidelink carriers is to be included in the determination of the number of HARQ-ACK information bits.

The text in Clause 9.1.3.1 in TS38.213 for Type 2 HARQ-ACK codebook generation may be updated as follows:

If O_{ACK}≤11, the UE determines a number of HARQ-ACK information bits N_{HARQ-ACK} for obtaining a transmission power for a PUCCH, as described in clause 7.2.1, as

$${n}_{HARQ - ACK} = ( {V}_{SAI , {m}_{last}}^{SL} - {\sum }_{c = 0}^{{N}_{cell}^{SL}} ) mod 4 {\sum }_{c = 0}^{{N}_{cell}^{SL}} ( {\sum }_{m = 0}^{M - 1} {N}_{m , c}^{received} + {N}_{CG , c} )$$

where
V_{SAI,m}_{ₗₐₛₜ}^{SL} is a value of a counter SAI field in a last DCI format 3_0, excluding the DCI format 3_0 activating a SL configured grant, scheduling PSSCH transmissions associated with PSFCH reception occasions that the UE detects within the M PDCCH monitoring occasions
V_{SAI,m}_{ₗₐₛₜ}^{SL}=0 if the UE does not detect any DCI format 3_0, excluding the DCI format 3_0 activating a SL configured grant, scheduling PSSCH transmissions associated with PSFCH reception occasions in any of the M PDCCH monitoring occasions
U_{SAI,c} is a total number of DCI format 3_0, excluding the DCI format 3_0 activating a SL configured grant, scheduling PSSCH transmissions associated with PSFCH reception occasions for sidelink carrier c, that the UE detects within the M PDCCH monitoring occasions. U_{SAI}=0 if the UE does not detect any DCI format 3_0, excluding the DCI format 3_0 activating a SL configured grant, scheduling PSSCH transmissions with associated PSFCH reception occasions in any of the M PDCCH monitoring occasions
N_{m,c}^{received} is a number of DCI format 3_0, excluding the DCI format 3_0 activating a SL configured grant, scheduling PSSCH transmissions with associated PSFCH reception occasions that the UE detects in PDCCH monitoring occasion m for sidelink carrier c,
N_{CG,c} is a number of SL configured grants for which the UE transmits corresponding HARQ-ACK information in a same PUCCH as for HARQ-ACK information corresponding to PSFCH reception occasions associated with PSSCH transmissions scheduled by a dynamic grant within the M PDCCH monitoring occasions for sidelink carrier c
N_{cell}^{SL} is a number of sidelink carriers.

In some aspects, if a SL configured grant is only supported in one sidelink carrier, the above equation may be updated as follows:

$${n}_{HARQ - ACK} = ( {V}_{SAI , {m}_{last}}^{SL} - {\sum }_{c = 0}^{{N}_{cell}^{SL}} {U}_{SAI , c} ) mod 4 + {\sum }_{c = 0}^{{N}_{cell}^{SL}} {\sum }_{m = 0}^{M - 1} {N}_{m , c}^{received} + {N}_{CG}$$

### Prioritization

In Rel-16, a UE is expected to transmit and receive a PSFCH carrying HARQ-ACK feedback in the same symbol. In this case, depending on the priority value of the PSFCHs, which are determined based on the priority of the associated PSSCH transmission, a UE may select to either transmit or receive the PSFCH due to the half-duplex constraint.

Similarly, when a PUCCH carrying sidelink HARQ-ACK information bits overlaps with a sidelink transmission including a PSSCH and PSFCH transmission, a UE may determine that the PUCCH has higher priority than the SL transmission if the priority value of the PUCCH is smaller than that of the sidelink transmission. In this case, if the UE is not capable of simultaneous sidelink and uplink transmissions in a same carrier or two respective carriers, the UE may transmit the PUCCH only and cancel the sidelink transmission. Otherwise, the UE may transmit sidelink channels only and cancel the PUCCH if the sidelink transmission has higher priority than the PUCCH.

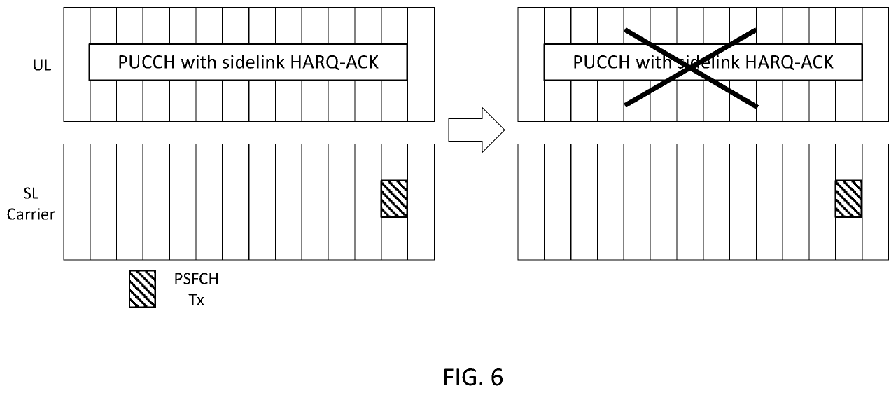

FIG. 6 illustrates prioritization of a PUCCH with sidelink HARQ-ACK feedback and physical sidelink feedback channel (PSFCH) transmission in accordance with some embodiments. In the example shown in FIG. 6, the PUCCH with sidelink HARQ-ACK feedback has priority value of 3, and the PSFCH transmission has priority value of 2, respectively. In this case, the UE determines that the PSFCH transmission has higher priority than the PUCCH transmission. If the UE is not capable of simultaneous transmission on uplink and sidelink on two carriers, the UE only transmits the PSFCH and cancels the PUCCH transmission.

In Rel-16 and Rel-17, only single carrier operation is considered for sidelink communication. For sidelink CA, when sidelink transmission and reception overlaps in time on different respective carriers, and if the UE is not capable of simultaneous transmission and reception on sidelink carriers, prioritization rule may be defined to allow the UE to only transmit or receive sidelink physical channels/signals on a single sidelink carrier. Similarly, prioritization rules may be defined in case sidelink transmission and/or reception on more than one sidelink carrier overlap with uplink transmission on uplink carrier. Collision handling for sidelink transmission and reception under CA scenarios are disclosed herein.

### Collison Handling for Sidelink Transmission and Reception Under CA Scenario

In one embodiment, a UE is expected to be (pre-) configured with the same set of slots for SL communication and S-SS/PBCH transmission for different sidelink carriers for sidelink CA. Further, a UE is expected to be (pre-) configured with the same periodicity for PSFCH transmission in different sidelink carriers. In this case, the same PSFCH transmission occasion in time can be configured for different carriers.

In one embodiment, when a UE is to transmit a first set of sidelink physical channels/signals in a first set of sidelink carriers and receive a second set of sidelink physical channels/signals in a second set of sidelink carriers simultaneously, i.e., the first and second set of sidelink physical channels/signals overlap in time: the UE first determines the priority value of the sidelink transmissions as the smallest priority value among the sidelink transmissions in the first set of sidelink physical channels/signals, and the UE determines the priority value of the sidelink receptions as the smallest priority value among the sidelink receptions in the second set of sidelink physical channels/signals.

If the determined priority value of the sidelink transmissions of the first set of sidelink physical channels/signals is smaller than the determined priority value of the sidelink reception of the second set of sidelink physical channels/signals, the first set of sidelink physical channels/signals have higher priority than the second set of sidelink physical channels/signals; otherwise, the second set of sidelink physical channels/signals have higher priority than the first set of sidelink physical channels/signals.

In addition, if the UE is not capable of simultaneous transmission and reception of sidelink physical channels/signals in two or more respective carriers, a UE only transmits or only receives sidelink physical channel(s)/signal(s) based on which one has the higher priority.

The first and second set of sidelink physical channel/signal may include one or more of the following: sidelink synchronization signal (S-SS) and physical sidelink broadcast channel (PSBCH), PSSCH and PSCCH, PSFCH, or sidelink-positioning reference signal (SL-PRS).

In some aspects, the first set of sidelink physical channels/signals may only include a sidelink physical channel on a first sidelink carrier; the second set of sidelink physical channel/signal may only include a sidelink physical channel on a second sidelink carrier.

In one example, when PSSCH/PSCCH transmissions in a first set of sidelink carriers overlap in time with PSFCH receptions for a second set of sidelink carriers, and if the smallest priority value among PSSCH/PSCCH transmissions is smaller than the smallest priority value among PSFCH receptions, the PSSCH/PSCCH transmissions in the first set of sidelink carriers have higher priority than the PSFCH receptions in the second set of sidelink carriers; otherwise, the PSFCH receptions in the second set of sidelink carriers have a higher priority than the PSSCH/PSCCH transmissions in the first set of sidelink carriers.

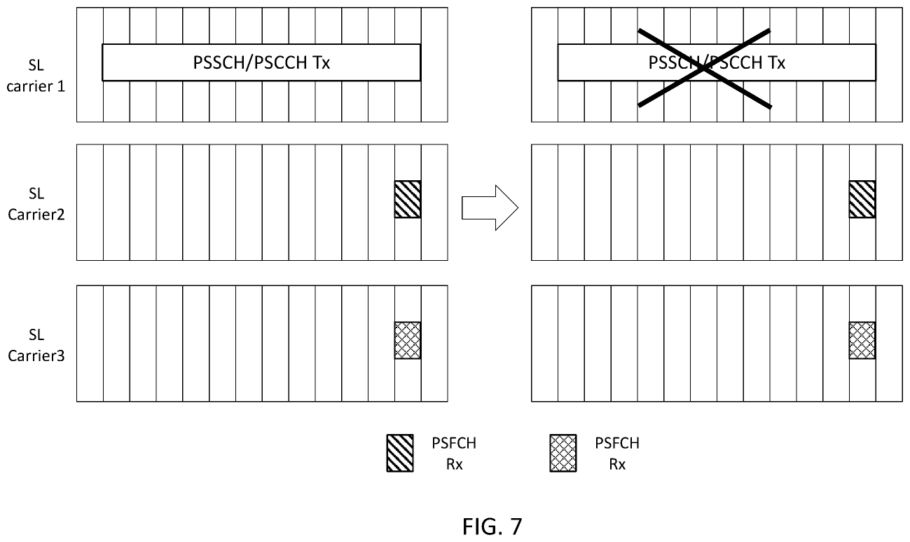

FIG. 7 illustrates prioritization between PSSCH/PSCCH transmission and PSFCH reception in accordance with some embodiments. In the example shown in FIG. 7, the PSSCH/PSCCH transmission has priority value of 3, and the PSFCH receptions in sidelink carriers 2 and 3 have a priority value of 2 and 4, respectively. Based on the aforementioned rules, the PSFCH receptions have the priority value of 2 and have a higher priority than the PSSCH/PSCCH transmission. If the UE is not capable of simultaneous sidelink transmission and reception on more than two sidelink carriers, the UE cancels the PSSCH/PSCCH transmission in sidelink carrier 1 and receives the PSFCH in sidelink carrier 2 and 3 respectively.

In another example, when the S-SS/PSBCH reception for a first sidelink carrier overlaps with the PSFCH or PSSCH/PSCCH transmission for a second sidelink carrier in time, if the priority value of the S-SS/PSBCH is smaller than that of the PSFCH or PSSCH/PSCCH transmission, the S-SS/PSBCH reception has higher priority than the PSFCH or PSSCH/PSCCH transmission; otherwise, the PSFCH or PSSCH/PSCCH transmission has higher priority than the S-SS/PSBCH reception.

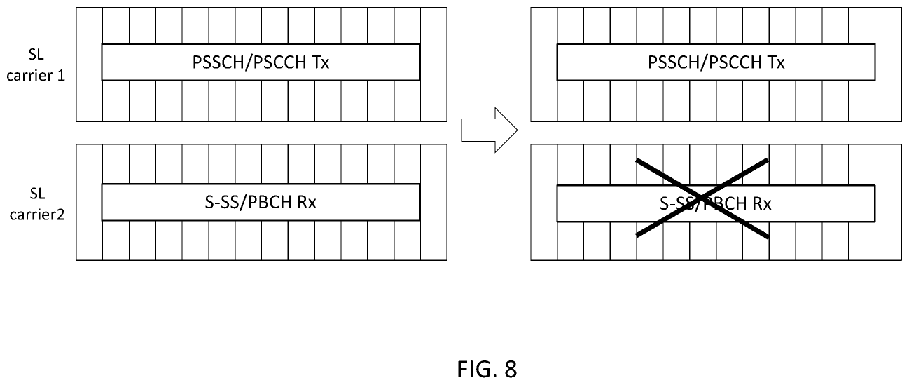

FIG. 8 illustrates prioritization between PSSCH/PSCCH transmission and PSFCH reception in accordance with some embodiments. In the example shown in FIG. 8, the PSSCH/PSCCH transmission has smaller priority value than the S-SS/PSBCH reception. Based on the prioritization rule as mentioned above, the PSSCH/PSCCH transmission has higher priority than the S-SS/PSBCH reception. If the UE is not capable of simultaneous sidelink transmission and reception on more than two sidelink carriers, the UE cancels the S-SS/PSBCH reception in sidelink carrier 2 and only transmits the PSSCH/PSCCH in sidelink carrier 1.

In another embodiment, when the UE is to transmit an uplink channel/signal in an uplink carrier, and transmit a first sidelink physical channel/signal in a first sidelink carrier and a second sidelink physical channel/signal in a second sidelink carrier simultaneously, the UE first determines the priority of the sidelink transmissions in the first and second carrier, which is the smallest priority value among the SL transmissions. Further, the UE determines the priority of the UL transmission and SL transmission in accordance with the prioritization for sidelink and uplink transmission/receptions as determined in Clause 16.2.4.3.1 in TS 38.213.

If the UE is not capable of simultaneous transmission of physical channels/signals in sidelink and uplink in more than one carrier, if the uplink transmission has a higher priority than the sidelink transmissions, the UE only transmits the uplink channel/signal in the uplink carrier; otherwise, if the determined the SL transmission has a higher priority than the uplink transmission, the UE transmits the sidelink transmission in the first and second sidelink carriers, respectively and drops/cancels the uplink transmission.

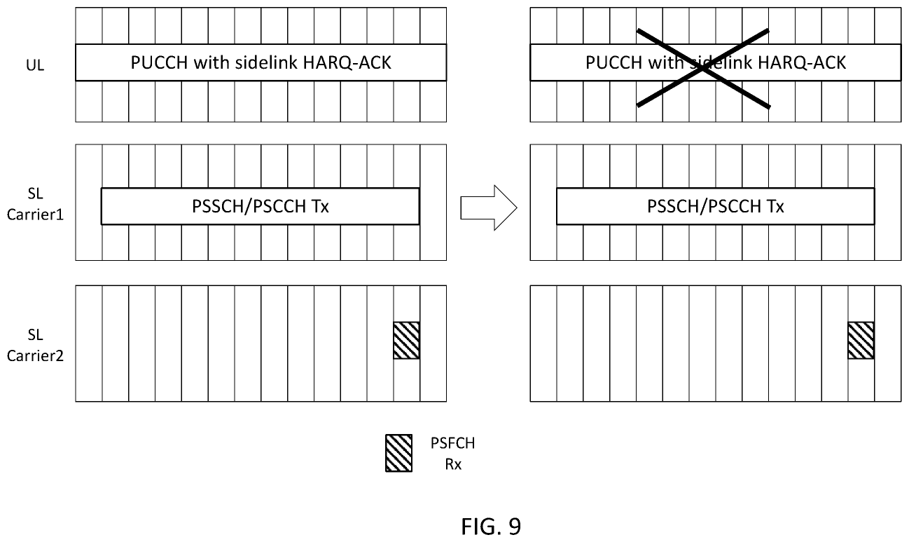

FIG. 9 illustrates prioritization between UL transmission and SL transmissions in more than one sidelink carrier in accordance with some embodiments. In the example shown in FIG. 9, a PUCCH with sidelink HARQ-ACK feedback has a priority value of 3, the PSSCH/PSCCH transmission has a priority value of 4, and the PSFCH transmission has a priority value of 2, respectively. Based on the aforementioned rule, the UE first determines that the SL transmission has priority value of 2. Further, the UE determines that the SL transmission has a higher priority than the UL transmission. If the UE is not capable of simultaneous uplink and sidelink transmission, the UE only transmits the PSSCH/PSCCH and PSFCH in two respective sidelink carriers and cancels the uplink transmission in the uplink carrier.

In another embodiment, when the UE is to transmit an uplink channel/signal in an uplink carrier, and receive a first sidelink physical channel/signal in a first sidelink carrier and a second sidelink physical channel/signal in a second sidelink carrier simultaneously, the UE first determines a priority of the sidelink transmissions in the first and second carrier to be the smallest priority value among the SL receptions. Further, the UE determines the priority of the UL transmission and SL receptions in accordance with the prioritization for sidelink and uplink transmission/receptions as determined in Clause 16.2.4.3.1 in TS38.213.

If the UE is not capable of simultaneous transmission on the uplink and reception on the sidelink in more than one carrier, if the uplink transmission has a higher priority than the sidelink receptions, the UE only transmits the uplink channel/signal in the uplink carrier; otherwise, if the determined SL transmission has a higher priority than the uplink transmission, the UE receives on the sidelink in the first and second sidelink carriers, respectively and drops/cancels the uplink transmission.

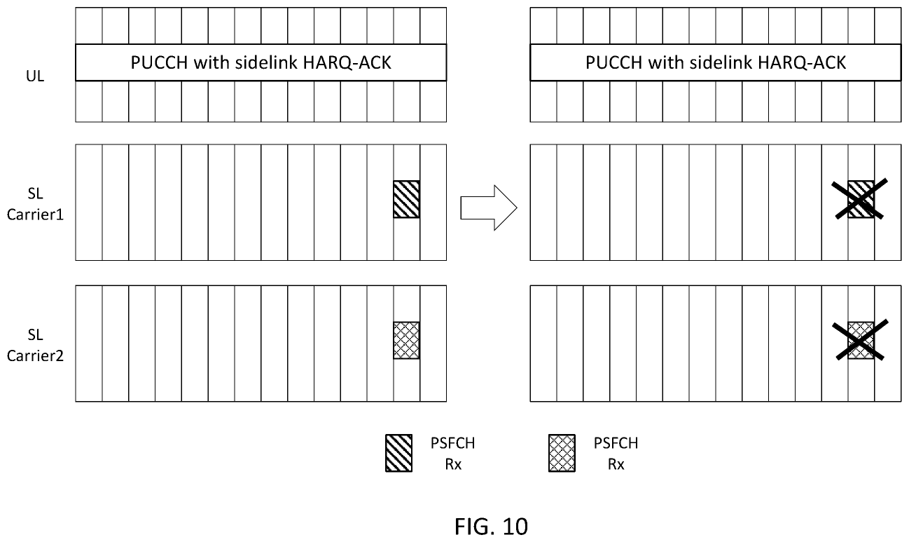

FIG. 10 illustrates prioritization between UL transmission and SL transmissions in more than one sidelink carrier in accordance with some embodiments. In the example shown in FIG. 10, a PUCCH with sidelink HARQ-ACK feedback has a priority value of 1, a PSFCH reception in SL carrier 1 has a priority value of 4, and a PSFCH reception in SL carrier 2 has a priority value of 3, respectively. Based on the aforementioned rule, the UE first determines that the PSFCH reception has a priority value of 2. Further, the UE determines that UL transmission has a higher priority than the SL reception. If the UE is not capable of simultaneous transmission and reception respectively on the uplink and sidelink carrier, the UE only transmits the PUCCH with sidelink HARQ-ACK feedback and cancels the PSFCH receptions in two respective sidelink carriers.

In another embodiment, when the UE is to transmit an uplink channel/signal in an uplink carrier, transmit a first set of sidelink physical channels/signals in a first set of sidelink carriers, and receive a second set of sidelink physical channels/signals in a second set of sidelink carriers simultaneously: the UE first determines the priority value of the sidelink transmissions as the smallest priority value among the sidelink transmissions in the first set of sidelink physical channels/signals; and the UE determines the priority value of the sidelink receptions as the smallest priority value among the sidelink receptions in the second set of sidelink physical channels/signals.

The UE first performs prioritization between the sidelink transmission(s) and reception(s) in the first and second set of sidelink carriers based on the determined priority values for the sidelink transmission(s) and reception(s), where the prioritization rule can be determined as mentioned above, i.e., the smaller priority value has the higher priority. Further, the UE performs the prioritization between the sidelink transmission(s) or receptions with higher priority and the uplink transmission based on the existing prioritization rule as defined in Clause 16.2.4.3 in TS38.213.

In one option, if the priority value of the uplink transmission is smaller than the determined priority value of the sidelink transmission and reception, and if the UE is not capable of simultaneous uplink transmission and sidelink transmission or reception, the UE only transmits the uplink channel/signal on the uplink carrier and cancels the sidelink transmission/reception in the first and second set of sidelink carriers.

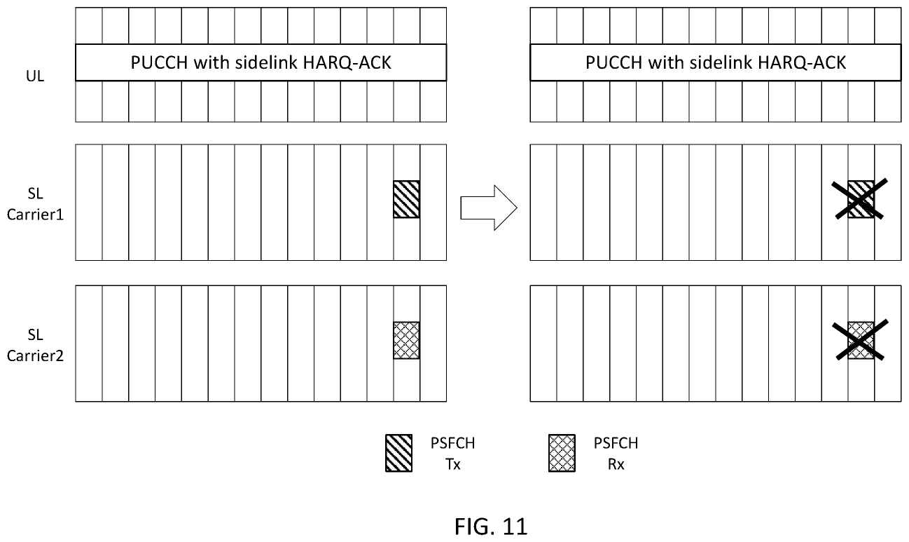

FIG. 11 illustrates prioritization between UL transmission, SL transmission, and SL reception in accordance with some embodiments. In the example shown in FIG. 11, a PUCCH with sidelink HARQ-ACK feedback has a priority value of 1, a PSFCH transmission in SL carrier 1 has a priority value of 4, and a PSFCH reception in SL carrier 2 has a priority value of 3, respectively. Based on the aforementioned rule, the PUCCH transmission has the highest priority. If the UE is not capable of simultaneous uplink transmission and sidelink transmission or reception, the UE only transmits the PUCCH, and cancels the PSFCH transmission in SL carrier 1 and PSFCH reception in SL carrier 2.

In another option, if the determined priority value of sidelink transmissions is smaller than the priority value of uplink transmission and the determined priority value of sidelink receptions, and if the UE is not capable of simultaneous uplink transmission and sidelink transmission or reception, the UE only transmits the sidelink physical channels/signals in the first set of sidelink carriers and cancels the uplink transmission and sidelink receptions in the second set of sidelink carriers.

In another option, if the determined priority value of sidelink receptions is smaller than the priority value of the uplink transmission and the determined priority value of sidelink transmissions, and if the UE is not capable of simultaneous uplink transmission and sidelink transmission or reception, the UE only receives the sidelink physical channels/signals in the second set of sidelink carriers and cancels the uplink transmission and sidelink transmissions in the first set of sidelink carriers.

In another option, if the priority value of the uplink transmission or sidelink transmission is smaller than the priority value of sidelink reception, if the UE is not capable of simultaneous uplink transmission and sidelink reception on two or more carriers, and if the UE is capable of simultaneous uplink transmission and sidelink transmission on two or more carriers, the UE transmits the uplink channel/signal on the uplink carrier and sidelink channel(s)/signal(s) in the first set of sidelink carriers, and cancels the sidelink reception in the second set of sidelink carriers.

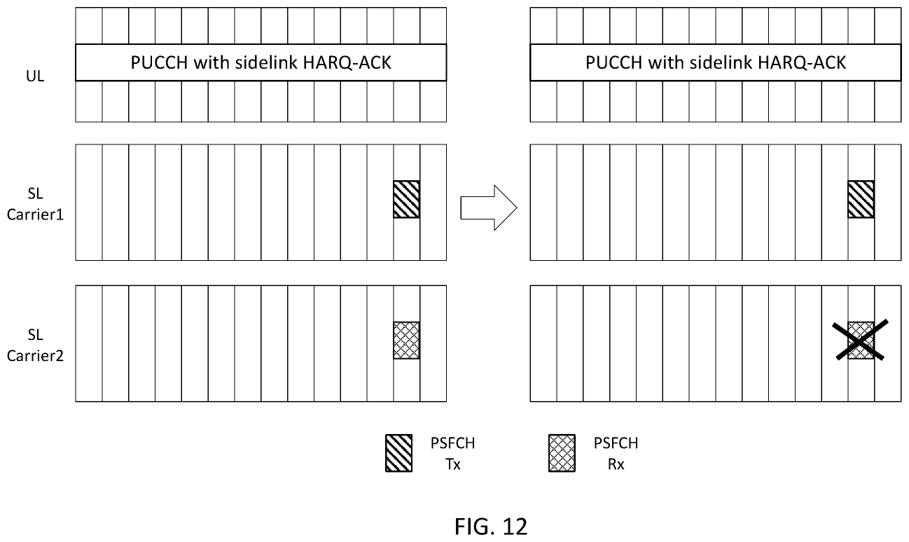

FIG. 12 illustrates another prioritization between UL transmission, SL transmission, and SL reception in accordance with some embodiments. In the example shown in FIG. 12, a PUCCH with sidelink HARQ-ACK feedback has priority value of 1, a PSFCH transmission in SL carrier 1 has priority value of 4, and a PSFCH reception in SL carrier 2 has priority value of 3, respectively. Based on the aforementioned rule, the PUCCH transmission has a higher priority than the PSFCH reception. If the UE is not capable of simultaneous uplink transmission and sidelink reception on two or more carriers, and if the UE is capable of simultaneous uplink transmission and sidelink transmission on two or more carriers, the UE transmits the PUCCH and the PSFCH in SL carrier 1, and cancels the PSFCH reception in SL carrier 2.

In another embodiment, when the determined priority value of the sidelink transmissions in the first set of sidelink carriers is same as the determined priority value of the sidelink receptions in the second set of sidelink carriers, in one option, the sidelink transmissions have a higher priority than the sidelink receptions. In this case, if a UE is not capable of simultaneous transmission and reception of sidelink physical channels/signals in two or more respective carriers, the UE transmits the sidelink physical channels/signals and cancels the sidelink receptions.

In another option, the sidelink receptions have a higher priority than the sidelink transmissions. In this case, if a UE is not capable of simultaneous transmission and reception of sidelink physical channels/signals in two or more respective carriers, the UE receives the sidelink physical channels/signals and cancels the sidelink transmissions.

In another option, whether sidelink transmissions or receptions have a higher priority can be (pre-) configured by higher layers. In this case, if the UE is not capable of simultaneous transmission and reception of sidelink physical channels/signals in two or more respective carriers, the UE transmits or receives the sidelink physical channels/signals in accordance with the configuration.

In another embodiment, if the UE is capable of simultaneous transmissions on more than one sidelink carrier, and the UE is to transmit on more than one sidelink carrier where the transmissions on more than one sidelink carriers overlap over a time period, if the total UE transmission power over the time period would exceed P_{CMAX}: the UE reduces the power for the SL transmission prior to the SL transmission on a first sidelink carrier, if the SL transmission on a second sidelink carrier has a higher priority than the first sidelink carrier, so that the total UE transmission power does not exceed P_{CMAX}; and the UE reduces the power for the SL transmission prior to the SL transmission on a second sidelink carrier, if the SL transmission on a first sidelink carrier has a higher priority than the second sidelink carrier, so that the total UE transmission power does not exceed P_{CMAX}.

In another embodiment, if a UE is capable of simultaneous transmissions on uplink carrier and more than one sidelink carrier, and the UE is to transmit on the uplink carrier and more than one sidelink carrier where the transmissions on the uplink carrier and more than one sidelink carrier overlap over a time period if the total UE transmission power over the time period exceeds P_{CMAX}, the UE allocates power to the UL transmission and sidelink transmissions in descending order based on the priority value of the UL transmission and sidelink transmissions. In particular, the transmission with the smallest priority value has the highest priority, followed by the transmission with second smallest priority value, and so on.

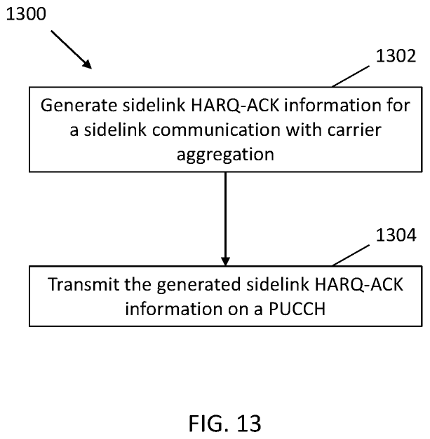

In some embodiments, the electronic devices, networks, systems, chips or components, or portions or implementations thereof, of the above figures may be configured to perform one or more processes, techniques, or methods as described herein, or portions thereof. One such process that may be performed by a UE or a portion thereof is depicted in FIG. 13. FIG. 13 illustrates a process of providing sidelink HARQ-ACK information in accordance with some embodiments. For example, the process 1300 may include, at operation 1302, generating sidelink HARQ-ACK information for a sidelink communication with carrier aggregation. At operation 1304, the process 1300 may further include transmitting the generated sidelink HARQ-ACK information on a PUCCH.

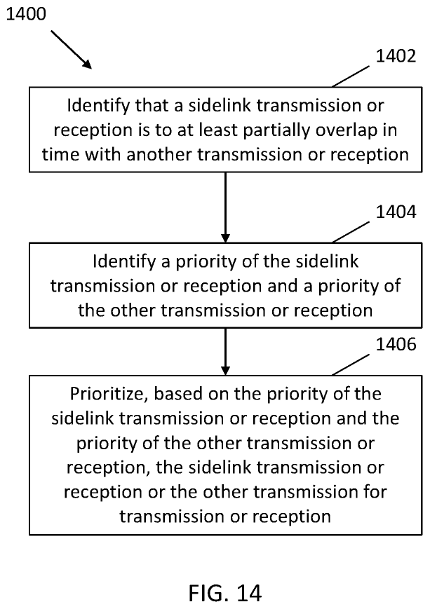

FIG. 14 illustrates a process of prioritization of transmissions or reception including sidelink transmissions and receptions in accordance with some embodiments. The process 1400 of FIG. 14 may include or relate to a method to be performed by a UE, one or more elements of a UE, and/or one or more electronic devices that include and/or implement one or more elements of a UE. The process 1400 may include identifying, at operation 1402, that a sidelink transmission or reception is to at least partially overlap in time with another transmission or reception; identifying, at operation 1404, a priority of the sidelink transmission or reception and a priority of the other transmission or reception; and prioritizing, at operation 1406 based on the priority of the sidelink transmission or reception and the priority of the other transmission or reception, the sidelink transmission or reception or the other transmission for transmission or reception.

### Examples

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1-20. (canceled)

21. An apparatus for a user equipment (UE), the apparatus comprising:
processing circuitry configured to:
generate Type 1 or Type 2 sidelink hybrid automatic repeat request-acknowledgement (HARQ-ACK) information bits for sidelink carrier aggregation; and
encode, for transmission to a fifth generation NodeB (gNB), the Type 1 or Type 2 sidelink HARQ-ACK information bits on a physical uplink control channel (PUCCH) using sidelink carrier aggregation; and
memory configured to store the Type 1 or Type 2 sidelink HARQ-ACK information bits.

22. The apparatus of claim 21, wherein the processing circuitry is further configured to decode, from the gNB, downlink control information (DCI) having a DCI format 3_0, the DCI including a sidelink carrier index that indicates a sidelink carrier for resource allocation of physical sidelink control channel (PSCCH) and physical sidelink shared channel (PSSCH).

23. The apparatus of claim 21, wherein the processing circuitry is further configured to, for Type 1 sidelink HARQ-ACK codebook generation for sidelink carrier aggregation, generate sidelink HARQ-ACK bits per sidelink carrier and concatenate the sidelink HARQ-ACK bits in an ascending order of sidelink serving cell index.

24. The apparatus of claim 21, wherein:
the processing circuitry is further configured to decode, from the gNB, downlink control information (DCI) having a DCI format 3_0, and
the DCI format 3_0 has a field of total sidelink assignment index (T-SAI) that indicates a total number of sidelink HARQ-ACK feedback information bits for sidelink carrier aggregation for Type 2 HARQ-ACK codebook generation.

25. The apparatus of claim 21, wherein:
the processing circuitry is further configured to decode, from the gNB, downlink control information (DCI) having a DCI format 3_0, and
a set of physical downlink control channel (PDCCH) monitoring occasions for the DCI format 3_0 for scheduling physical sidelink shared channel (PSSCH) transmissions with associated physical sidelink feedback channel (PSFCH) reception occasions is defined as a union of PDCCH monitoring occasions in an active downlink (DL) bandwidth part (BWP) of configured serving cells, in ascending order of start time of associated search space sets.

26. The apparatus of claim 21, wherein:
the processing circuitry is further configured to decode, from the gNB, downlink control information (DCI) having a DCI format 3_0, and
a value of a counter sidelink assignment index (SAI) field in the DCI format 3_0, excluding a DCI format 3_0 for a sidelink (SL)-configured grant Type 2 activation, denotes an accumulative number of {sidelink carrier, physical downlink control channel (PDCCH) monitoring occasions}-pairs where physical sidelink shared channel (PSSCH) transmissions with associated physical sidelink feedback channel (PSFCH) receptions are scheduled, up to a current PDCCH monitoring occasion, first in ascending order of sidelink carrier index and then in ascending order of PDCCH monitoring occasion index.

27. The apparatus of claim 21, wherein:
the processing circuitry is further configured to decode, from the gNB, downlink control information (DCI) having a DCI format 3_0, and
a value of a total sidelink assignment index (SAI), when present, in the DCI format 3_0, excluding DCI format 3_0 for a sidelink (SL)-configured grant Type 2 activation, denotes a total number {sidelink carrier, physical downlink control channel (PDCCH) monitoring occasions}-pairs where physical sidelink shared channel (PSSCH) transmissions with associated physical sidelink feedback channel (PSFCH) receptions are scheduled, up to a current PDCCH monitoring occasion, and is updated between PDCCH monitoring occasions.

28. The apparatus of claim 21, wherein the processing circuitry is further configured to use a total sidelink assignment index (T-SAI) and sidelink carrier index in pseudo-code for Type 2 HARQ-ACK codebook generation on the PUCCH.

29. The apparatus of claim 21, wherein the processing circuitry is further configured to determine, for power control of a PUCCH carrying sidelink HARQ-ACK information bits, a number of the sidelink HARQ-ACK information bits based on a number of sidelink carriers.

30. The apparatus of claim 21, wherein the processing circuitry is further configured to:
configure or indicate a priority value for a sidelink physical channel or signal; and
determine, for sidelink carrier aggregation, whether the sidelink physical channel or signal has a higher priority than another sidelink physical channel or signal or uplink transmission.

31. The apparatus of claim 30, wherein the sidelink physical channel or signal is selected from a group of sidelink physical channels and signals that includes: a sidelink synchronization signal (S-SS) and physical sidelink broadcast channel (PSBCH), a physical sidelink shared channel (PSSCH) and physical sidelink control channel (PSCCH), physical sidelink feedback channel (PSFCH), and sidelink positioning reference signal (SL PRS).

32. The apparatus of claim 31, wherein the processing circuitry is further configured to:
determine, for sidelink carrier aggregation, that a first set of sidelink physical channels or signals to be transmitted in a first set of sidelink carriers and a second set of sidelink physical channels or signals to be received in a second set of sidelink carriers overlap in time;
set a priority value of sidelink transmissions as a smallest priority value among sidelink transmissions in the first set of sidelink physical channels or signals and a priority value of sidelink receptions as a smallest priority value among sidelink receptions in the second set of sidelink physical channels or signals; and
determine a smallest priority value between the priority value of sidelink transmissions and the priority value of sidelink receptions as a highest priority.

33. The apparatus of claim 21, wherein the processing circuitry is further configured to:
determine that an uplink channel or signal is to be transmitted in an uplink carrier, and a first sidelink physical channel or signal in a first sidelink carrier and a second sidelink physical channel or signal in a second sidelink carrier are to be simultaneously transmitted or received;
determine a priority of sidelink transmissions in the first sidelink carrier and the second sidelink carrier, the priority being a smallest priority value among the sidelink transmissions in the first sidelink carrier and the second sidelink carrier; and
select the sidelink transmissions having the smallest priority value to transmit or receive.

34. The apparatus of claim 21, wherein the processing circuitry is further configured to:
prioritize sidelink transmissions and sidelink receptions in a first set of sidelink carriers and a second set of sidelink carriers based on priority values for the sidelink transmissions and the sidelink receptions, where a smaller priority value has higher priority; and
in response to a determination that a priority value of the sidelink transmissions in the first set of sidelink carriers is identical to the priority value of the sidelink receptions in the second set of sidelink carriers, prioritize the sidelink transmissions in the first set of sidelink carriers over the sidelink receptions in the second set of sidelink carriers.

35. The apparatus of claim 21, wherein the processing circuitry is further configured to, for a UE having a capability of simultaneous transmissions on more than one sidelink carrier:
determine that transmissions over the more than one sidelink carrier are to overlap over a time period;
determine that a total UE transmission power over the time period is to exceed a maximum UE transmission power; and
in response to a determination that the total UE transmission power over the time period is to exceed the maximum UE transmission power, reduce power for a sidelink transmission on one of the more than one sidelink carrier, the sidelink transmission on the one of the more than one sidelink carrier having a lower priority than a sidelink transmission on another of the more than one sidelink carrier, the power of the sidelink transmission on the one of the more than one sidelink carrier being reduced to reduce the total UE transmission power to at most the maximum UE transmission power.

36. The apparatus of claim 21, wherein the processing circuitry is further configured to, for a UE having a capability of simultaneous transmissions on an uplink carrier and more than one sidelink carrier:
determine that an uplink transmission over the uplink carrier and sidelink transmissions over the more than one sidelink carrier are to overlap over a time period;
determine that a total UE transmission power over the time period is to exceed a maximum UE transmission power; and
in response to a determination that the total UE transmission power over the time period is to exceed the maximum UE transmission power, allocate power to the uplink transmission and the sidelink transmissions in descending order based on a priority value of the uplink transmission and the sidelink transmissions.

37. An apparatus for a fifth generation NodeB (gNB), the apparatus comprising:
processing circuitry configured to:
encode, for transmission to a user equipment (UE), downlink control information (DCI) having a DCI format 3_0, the DCI format 3_0 having a field of total sidelink assignment index (T-SAI) that indicates a total number of sidelink hybrid automatic repeat request-acknowledgement (HARQ-ACK) feedback information bits for sidelink carrier aggregation; and
decode, from the UE, a Type 1 or Type 2 sidelink HARQ-ACK information bits on a physical uplink control channel (PUCCH) on which sidelink carrier aggregation has been used; and
memory configured to store the DCI.

38. The apparatus of claim 37, wherein the DCI includes a sidelink carrier index that indicates a sidelink carrier for resource allocation of physical sidelink control channel (PSCCH) and physical sidelink shared channel (PSSCH).

39. A non-transitory computer-readable storage medium that stores instructions for execution by one or more processors of a user equipment (UE), the one or more processors to configure the UE to, when the instructions are executed:
generate Type 1 or Type 2 sidelink hybrid automatic repeat request-acknowledgement (HARQ-ACK) information bits for sidelink carrier aggregation; and
encode, for transmission to a fifth generation NodeB (gNB), the Type 1 or Type 2 sidelink HARQ-ACK information bits on a physical uplink control channel (PUCCH) using sidelink carrier aggregation.

40. The non-transitory computer-readable storage medium of claim 39, wherein the instructions, when executed, further configure the one or more processors to cause the UE to:
determine that an uplink channel or signal is to be transmitted in an uplink carrier, and a first sidelink physical channel or signal in a first sidelink carrier and a second sidelink physical channel or signal in a second sidelink carrier are to be simultaneously transmitted or received;
determine a priority of sidelink transmissions in the first sidelink carrier and the second sidelink carrier, the priority being a smallest priority value among the sidelink transmissions in the first sidelink carrier and the second sidelink carrier; and
select the sidelink transmissions having the smallest priority value to transmit or receive.
